(19) United States
(12) Patent Application Publication
(10) Pub. No.: US 2009/0237336 A1
(43) Pub. Date: Sep. 24, 2009

(54) DISPLAY METHOD AND DISPLAY DEVICE

(75) Inventor: Dai TANAKA, Shiojiri (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/405,285

(22) Filed: Mar. 17, 2009

(30) Foreign Application Priority Data
Mar. 19, 2008 (JP) 2008-072103

(51) Int. Cl. G09G 3/36

(52) U.S. Cl. 345/88

(57) ABSTRACT

A display method in a display device having a display area including plural pixels and in which color of each pixel is rewritten only from one color to another color in one image writing process is disclosed. The method includes: displaying plural display items in the display area; specifying a display item selected from the displayed plural display items; rewriting the color of the pixel located at a position corresponding to a first display item specified by the specifying, from a first color to a second color; and displaying a first specifying image showing that the first display item is specified, and when a second display item is specified after the first display item is specified, rewriting the color of the pixel located at a position corresponding to the second display item from the first color to the second color while keeping the first specifying image displayed, and displaying in the display area a second specifying image showing that the second display item is specified.

### BACKGROUND

1. Technical Field

The present invention relates to a technique of rewriting the color of a pixel and thus displaying an image.

2. Related Art

For display devices of information processing apparatuses such as personal computers and mobile phones, a CRT (cathode ray tube) and TN (twisted nematic) liquid crystal is broadly used. These display device are so-called “volatile display devices” which cannot perform display when power is not supplied. When power is supplied, since the volatile display device carries out rewriting dozens of times per second, a change made by a user via an input device is immediately reflected on the display device. For example, it is assumed that the user is caused to select a specific display item in a display state as shown in FIG. 11A. FIG. 11B shows an exemplary display which specifies a display item that is now selected, by highlighting the selected display item. Here, “3 Notice of Suspension of Newspaper Publication” is selected. FIG. 11C shows an exemplary display which specifies a display item that is selected now, by using a cursor of a particular shape. Here, an icon in the form of a solid-while triangle facing to the left is used as a cursor. As this cursor is displayed to the left side of the display item that is selected, it is shown that “3 Notice of Suspension of Newspaper Publication” is selected, similar to FIG. 11B.

As an improvement of these techniques, for example, JP-A-2007-240925 discloses a technique to increase visibility by varying the scroll speed of a display item and the moving speed of a cursor.

Recently, display devices having memorability (hereinafter referred to as “memorable display device”) such as EPDs (electrophoresis displays) and cholesteric liquid crystal displays are being developed. Here, memorability means that display contents are held without carrying out particular holding operation. Generally, a memorable display device of this type has a disadvantage that it takes a longer time for rewriting than a volatile display device.

Thus, when the user is caused to select a display item using a memorable display device, it is conceivable to use so-called “partial rewriting”, which rewrites only a part of the display device.

In the case of a cholesteric liquid crystal display, a simple passive matrix system may be used. The simple passive matrix system is a method of arranging plural electrodes in each row and each column on the display surface of the display device and driving pixels at points of intersection. In this case, since a particular row or column is rewritten simultaneously, partial rewriting on the row basis or column basis is efficient. For example, in the case of FIG. 11B, it suffices to rewrite only the row where “3 Notice of Suspension of Newspaper Publication” is displayed. In the case of FIG. 11C, it suffices to rewrite only the column where the icon selecting a display item is displayed. JP-A-2007-3754 and JP-A-2007-4223 disclose methods for such partial rewriting.

In the case of EPD, an active matrix system can be used. The active matrix system is a system of controlling pixels by using a transistor prepared for each pixel, which is different from the simple passive matrix system. As a specific example of active matrix EPD, there is an EPD in which an array of active matrix elements formed by TFTs (thin film transistors) using a low-temperature polysilicon film is coated with an encapsulated electrophoretic element. JP-A-2002-149115 discloses a refresh display method in which after all the pixels electrodes as the active matrix elements are held at the same potential, a voltage is applied between a common electrode and the pixel electrodes, thereby erasing the entire display contents.

In the active matrix EPD as described above, when clarifying a display item selected by the user, it is theoretically possible to carry out partial rewriting on the pixel basis since each pixel is provided with a transistor. However, the proximity of a voltage required for driving the electrophoretic element and a voltage which the transistor can withstand and the configuration using one common electrode per display surface cause a restraint on the active matrix EPD. That is, in one image writing process, it is impossible to simultaneously rewrite one pixel from white to black and rewrite another pixel from black to white. Particularly in the case of an active matrix EPD using both a transistor and a capacitor on the pixel electrode side, it takes time to accumulate electricity in the capacitor and therefore timing of switching the electric charge of the common electrode does not coincide with timing of switching the electric charge of the pixel electrode. Consequently, in such an active matrix EPD, it may require several hundred milliseconds to several seconds to shift from the operation of rewriting from white to black to the operation of rewriting from black to white. Therefore, for example, when a list as shown in FIG. 11A is displayed on the active matrix EPD and a display item is selected from the list, if the display item that is selected now is to be clarified by highlighting as shown in FIG. 11B, it is necessary to first rewrite only the character part of, for example, “3 Notice of Suspension of Newspaper Publication” from black to white, and then rewrite the non-character part from white to black. This alone takes time equivalent to carrying out the image writing process twice. Meanwhile, if each display item is selected one after another from top to bottom of the list, the two image writing processes as described above must be carried out sequentially for each display item. In some cases, it takes more than 10 seconds to reach the display item at the bottom of the list. This significantly lowers operability.

### SUMMARY

An advantage of some aspects of the invention is that even if there is a restraint that the color of each pixel is rewritten only from one color to another color in one image writing process in a display area, which display item is selected can be shown in a short time.

According to an aspect of the invention, a display device includes: a display unit which has a display area including plural pixels and in which color of each pixel is rewritten only from one color to another color in one image writing process in the display area; an item display control unit which displays plural display items in the display area; a specifying unit which specifies a display item selected by a user, from the displayed plural display items; and a specifying image display control unit which, when a first display item is specified by the specifying unit from the plural display items, rewrites the color of the pixel located at a position corresponding to the first display item from a first color to a second color and displays in the display area a first specifying image showing that the first display item is specified, and when a second display item is specified by the specifying unit after the first display item is specified, rewrites the color of the pixel located at a position corresponding to the second display item from the first color to the second color while keeping the first specifying image displayed, and displays in the display area a second specifying image showing that the second display item is specified.

It is preferable that the specifying image display control unit rewrites the color of the pixel located at the position corresponding to the second display item from the first color to the second color, and displays in the display area the second specifying image which shows that the second display item is specified and which enables identification of a specifying order of the first display item and the second display item.

It is also preferable that when a display item specified by the specifying unit in the past is selected by a user and specified again by the specifying unit, the specifying image display control unit displays the second specifying image at a position which is different from the position of the specifying image displayed when the display item is specified by the specifying unit in the past and which corresponds to the display item specified again by the specifying unit.

It is also preferable that the specifying image display control unit displays an image in a predetermined shape as the first specifying image at a position corresponding to the first display item, displays an image in a predetermined shape as the second specifying image at a position which corresponds to the second display item and is in an arraying direction of the display item as viewed from the image in the predetermined shape displayed corresponding to the first display item, displays a trajectory image connecting the image in the predetermined shape displayed at the position corresponding to the first display item and the image in the predetermined shape displayed at the position corresponding to the second display item, as the second specifying image, stores a direction from the first display item toward the second display item in accordance with an arraying order of the display items in the display area, and displays the second specifying image at a position which is different from the already displayed trajectory image and from a position on an extended line of the trajectory image, in displaying the second specifying image when the stored direction is changed.

It is also preferable that if the number of times the direction is changed exceeds a threshold value, the specifying image display control unit rewrites the color of a pixel representing the displayed specifying image from the second color to the first color and erases the specifying image.

It is also preferable that the specifying image display control unit measures an elapsed time after the second specifying image is displayed, and if the elapsed time exceeds a threshold value, the specifying image display control unit rewrites the color of at least a part of plural pixels representing the specifying image displayed before the second specifying image, from the second color to the first color.

According to another aspect of the invention, a program causes a computer of a display device having a display unit which has a display area including plural pixels and in which color of each pixel is rewritten only from one color to another color in one image writing process in the display area, to function as: an item display control unit which displays plural display items in the display area; a specifying unit which specifies a display item selected by a user, from the displayed plural display items; and a specifying image display control unit which, when a first display item is specified by the specifying unit from the plural display items, rewrites the color of the pixel located at a position corresponding to the first display item from a first color to a second color and displays in the display area a first specifying image showing that the first display item is specified, and when a second display item is specified by the specifying unit after the first display item is specified, rewrites the color of the pixel located at a position corresponding to the second display item from the first color to the second color while keeping the first specifying image displayed, and displays in the display area a second specifying image showing that the second display item is specified.

With the display device according to the aspect of the invention, even if there is a restraint that the color of each pixel is rewritten only from one color to another color in one image writing process in a display area, which display item is selected can be shown in a short time.

### BRIEF DESCRIPTION OF THE DRAWINGS

The invention will be described with reference to the accompanying drawings, wherein like numbers reference like elements.

FIG. 1 shows an exemplary external appearance of a display terminal.

FIG. 2 is a block diagram showing an exemplary functional configuration of the display terminal.

FIG. 3 schematically shows the structure of a display body of the display terminal.

FIG. 4A to FIG. 4C are sectional views schematically showing the structure and state of an electrophoretic element.

FIG. 5A to FIG. 5D are schematic views for explaining the reason why the display body of the display terminal cannot simultaneously rewrite one pixel from white to black and another pixel from black to white.

FIG. 6 is a flowchart for explaining a flow of operation in which the display terminal displays a cursor indicating a display item selected by a user on the surface of the display body.

FIG. 7A to FIG. 7C illustrate how the display terminal displays state transition of display item selection.

FIG. 8A and FIG. 8B illustrate how the display terminal displays state transition of display item selection.

FIG. 9A to FIG. 9C show how the display terminal displays state transition of display item selection in a modification.

FIG. 10A to FIG. 10D show how the display terminal displays state transition of display item selection in a modification.

FIG. 11A to FIG. 11C show how the display terminal displays state transition of display item selection in a traditional technique.

### DESCRIPTION OF EXEMPLARY EMBODIMENTS

Hereinafter, embodiments of the invention will be described with reference to the drawings.

### A. Configuration

### A-1. Configuration of Display Terminal

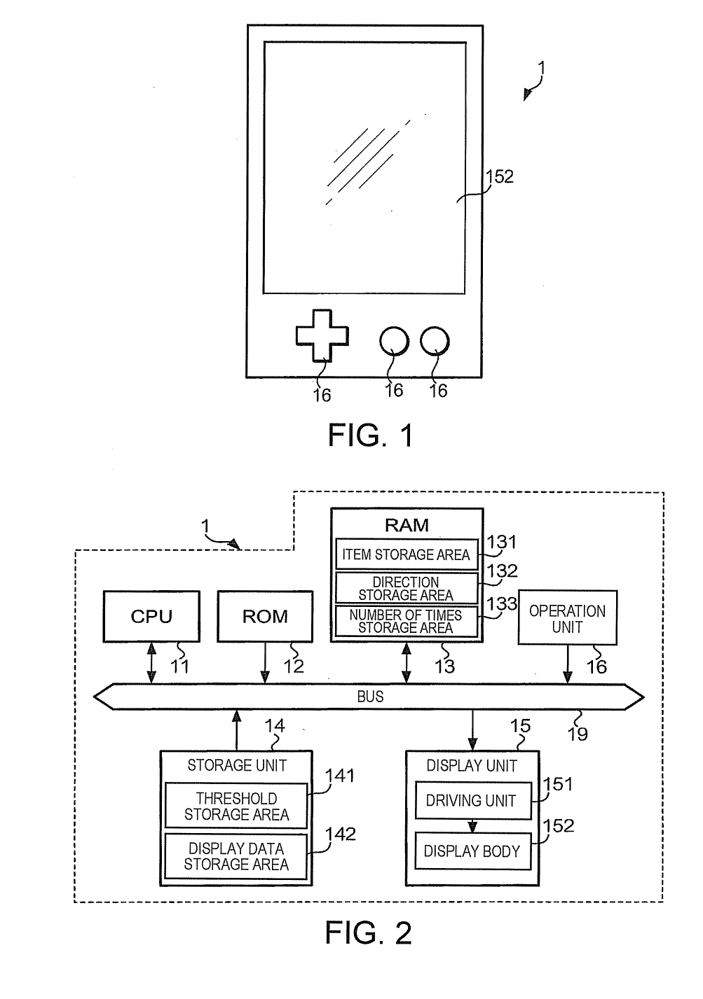

FIG. 1 shows an exemplary external appearance of a display terminal 1. FIG. 2 is a block diagram showing an exemplary functional configuration of the display terminal 1.

As shown in FIG. 1, an operation unit 16 and a display body 152 are provided on the front side of the display terminal 1.

As shown in FIG. 2, the display terminal 1 has a CPU (central processing unit) 11, a ROM (read only memory) 12, a RAM (random access memory) 13, a storage unit 14, a display unit 15 and an operation unit 16. These constituent units 11 to 16 are connected to a bus 19 and also connect to a power source unit, not shown, by a power line, not shown. The CPU 11 reads out and executes a computer program stored in the ROM 12 and thereby controls each part of the display terminal 1. The ROM 12 is a read-only non-volatile storage device in which the above computer program is stored. The RAM 13 is used as a work area when the CPU 11 executes a program. The RAM 13 also has an item storage area 131, a direction storage area 132 and a number of times storage area 133 in which store “display item that is now selected”, “direction” and “number of times” as parameters used in displaying the transition state of a selected display item are stored, respectively. The storage unit 14 is a rewritable non-volatile storage device, for example, a flash memory. The storage unit 14 has a threshold storage area 141 in which a threshold value as an upper limit value of the above “number of times” is stored, and a display data storage area 142 in which display data is stored. The display data includes data representing a list of plural display items as options and information corresponding to a display item selected by a user from this list. The operation unit 16 has direction buttons and switches to select a display item in the list displayed on the list screen. The operation unit 16 accepts an operation by the user and supplies a signal corresponding to the operation content (hereinafter referred to as operation signal) to the CPU 11. The display unit 15 is a display unit which displays an image under the control of the CPU 11. The display unit 15 has a reflection-type display body 152 having many electrophoretic elements and electrodes, and a driving unit 151 which converts a drawing command transmitted from the CPU 11 to a driving signal and drives each electrophoretic element by this driving signal. The display body 152 has a display area including plural pixels. This display unit 15 functions as a display unit in which the color of each pixel is rewritten only from one color to another color in one image writing process to the display area of the display body 152.

### A-2. Configuration of Display Body of Display Terminal

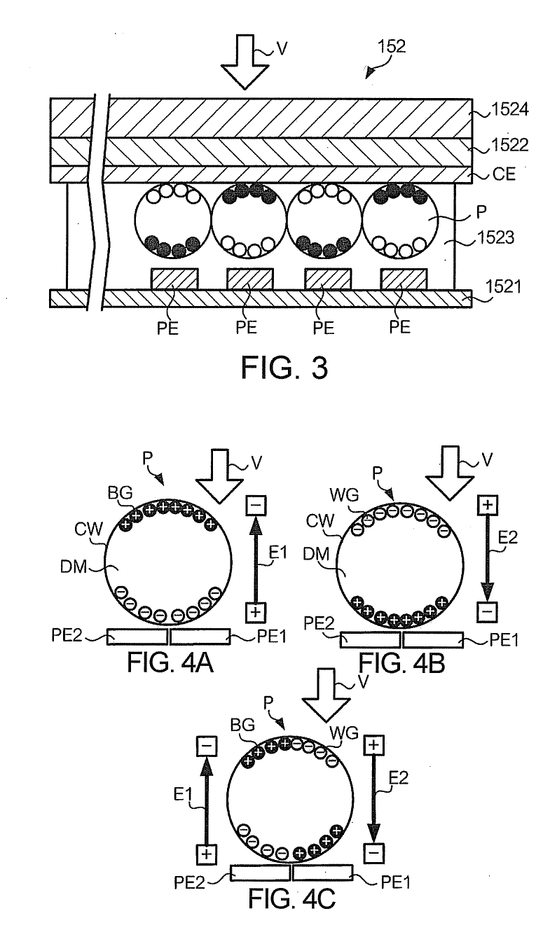

FIG. 3 schematically shows the structure of the display body 152 of the display terminal 1.

As shown in FIG. 3, the display body 152 includes a first substrate 1521, a second substrate 1522, an electrophoretic element P, a binder 1523 and an antireflection film 1524. In FIG. 3, the top side is the face side of the display surface, and the bottom side is the back side. The display body 152 is visually recognized by the user from the top, for example, from the direction of arrow V. The first substrate 1521 is a glass substrate. On its upper surface, plural pixel electrodes PE are arrayed in a regular lattice shape. All these pixel electrodes PE are squares having substantially the same size (approximately several ten microns). Specifically, these pixel electrodes are active matrix devices formed by TFT using a low-temperature polysilicon film. The second substrate 1522 facing the first substrate 1521 is a transparent resin substrate made of polyethylene terephthalate or the like. Under this second substrate 1522, a transparent common electrode CE made of ITO (indium tin oxide) is provided. Between the plural pixel electrodes PE and the common electrode CE, plural electrophoretic elements P are fixed by the light-transmissive binder 1523. These electrophoretic elements P are substantially spherical with a size of about several ten microns. These electrophoretic elements P are not perfectly the same in size and shape and are arrayed closely to each other. The antireflection film 1524 is attached to the upper side of the second substrate 1522. This antireflection film 1524 prevents sun light and illumination from being reflected on the surface of the display body 152.

FIG. 4A to FIG. 4C are sectional views schematically showing the structure and state of the electrophoretic element P. More specifically, FIG. 4A shows the state of the electrophoretic element P when black is displayed. FIG. 4B shows the state of the electrophoretic element P when white is displayed. FIG. 4C shows the state of the electrophoretic element P when black is displayed on the left side of FIG. 4C and white is displayed on the right side.

The electrophoretic element P is formed in a microcapsule, as shown in FIG. 4A to FIG. 4C. Inside a polymer film as a capsule wall CW, a liquid dispersant DM is enclosed which contains positively (+) charged black pigment particles BG and negatively (−) charged white pigment particle WG. The position of the black pigment particles BG and the white pigment particles WG is prescribed by an electric field provided from outside and is stably maintained by the dispersant DM. The actual grain diameter of the black pigment particles BG and the white pigment particles WG is approximately several nanometers, which is smaller than the size shown in the drawings. As described above, these electrophoretic elements P are not perfectly the same in size and shape and are fixed by the binder 1523, so to speak, in an irregularly arrayed state. Therefore, the electrophoretic elements P are not in a one-to-one correspondence with the pixel electrodes PE. FIG. 4A to FIG. 4C show the case where two pixel electrodes PE1 and PE2 are arranged to the back side of the electrophoretic element P, in order to simplify the explanation. However, depending on the size of the pixel electrodes, one pixel electrode may correspond to plural electrophoretic elements P, or three or more pixel electrodes may correspond to plural electrophoretic elements P.

When black is to be displayed by the electrophoretic elements P, as shown in FIG. 4A, a voltage that generates an electric field in the direction of arrow E1 in FIG. 4A is applied between the pixel electrode PE1 and the common electrode CE and between the pixel electrode PE2 and the common electrode CE by the driving unit 151. Thus, the positively (+) charged black pigment particles BG move inside the capsule wall CW toward the face side that is negatively (−) charged by the electric field. Similarly, the negatively (−) charged white pigment particles WG move inside the capsule wall CW toward the back side that is positively (+) charged by the electric field. Since the black pigment particles BG are thus gathered to the face side of the electrophoretic element P, the user recognizes black when observing this electrophoretic element P along arrow V from the face side. Meanwhile, when white is to be displayed by the electrophoretic element P, as shown in FIG. 4B, a voltage that generates an electric field in the direction of arrow E2 in FIG. 4B is applied between the pixel electrode PE1 and the common electrode CE and between the pixel electrode PE2 and the common electrode CE by the driving unit 151. Thus, the white pigment particles WG move toward the face side and the black pigment particles BG move toward the back side. Since the white pigment particles WG are thus gathered to the face side of the electrophoretic element P, the user recognizes white when observing this electrophoretic element P along arrow V from the face side.

One electrophoretic element P can not only display one color at a time but can display both white and black at the same time as shown in FIG. 4C. In this case, on the right side of the electrophoretic element P in FIG. 4C, a voltage that generates an electric field in the direction of arrow E1 in FIG. 4C is applied between the pixel electrode PE1 and the common electrode CE by the driving unit 151. On the left side of the electrophoretic element P in FIG. 4C, a voltage that generates an electric field in the direction of arrow E2 in FIG. 4C is applied between the pixel electrode PE2 and the common electrode CE by the driving unit 151. Thus, on the left side of the electrophoretic element P in FIG. 4C, the black pigment particles BG move toward the face side and the white pigment particles WG move toward the back side. On the right side of the electrophoretic element P in FIG. 4C, the white pigment particles WG move toward the face side and the black pigment particles BG move toward the back side.

The reason why the display body 152 of the display terminal 1 cannot simultaneously rewrite one pixel from white to black and another pixel from black to white in one image writing process will now be described.

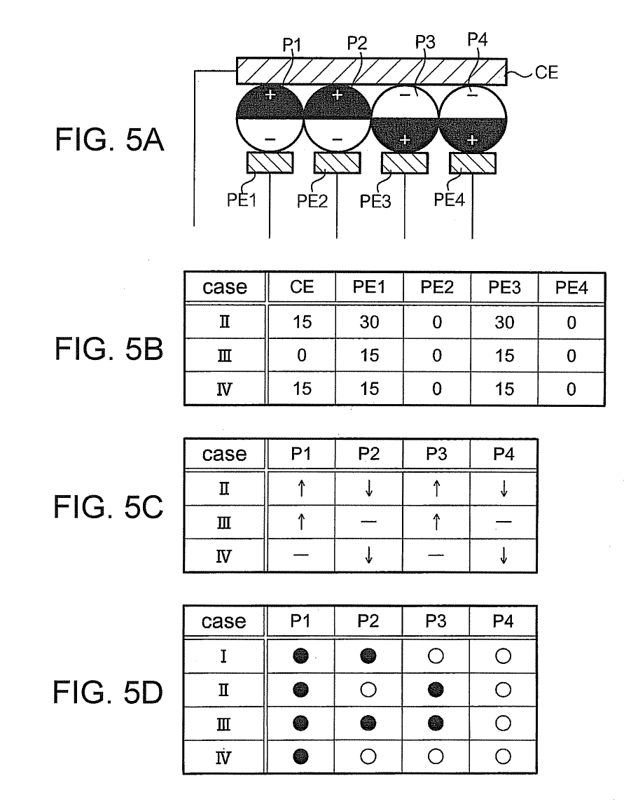

FIG. 5A is a schematic view for explaining this reason. FIG. 5B to FIG. 5D show the electric charge of the common electrode CE and pixel electrodes PE1 to PE4, the direction of an electric field, and the color of a pixel recognized from the surface. It is assumed that four electrophoretic elements P1 to P4, pixel electrodes PE1 to PE4 provided below these electrophoretic elements P1 to P4, respectively, and the common electrode CE provided above the electrophoretic elements P1 to P4 are arranged in the display body 152, as shown in FIG. 5A. This displaybody 152 is visually recognized by the user from above in FIG. 5A. Although the electrophoretic elements P and the pixel electrodes PE need not be in one-to-one correspondence, as described above, it is now assumed that the pixel electrodes PE1 to PE4 correspond to the electrophoretic elements P1 to P4, respectively, for convenience in explanation. Plural black pigment particles BG and white pigment particles WG exist in the electrophoretic elements P1 to P4. However, in FIG. 5A, instead of describing each particle, the semicircles express that the plural black or white particles move to the face side or back side.

The electrophoretic elements P1 to P4 shown in FIG. 5A are in the initial state. The electrophoretic elements P1 and P2 show black. The electrophoretic elements P3 and P4 show white. This initial state is referred to as CASE I. Now, CASE II which assumes that the TFTs of the pixel electrodes PE can withstand a voltage of 30 V will be explained. In CASE II, a voltage of 15 V is applied to the common electrode CE. A voltage of 30 V is applied to the pixel electrode PE 1 and PE 3, and 0 V is applied to the pixel electrodes PE2 and PE4 (see FIG. 5B). In this case, the electric charge of the pixel electrodes PE1 and PE3 exceeds the electric charge of the common electrode CE, generating a potential difference of +15 V upward. Therefore, both the electrophoretic elements P1 and P3 arranged to face the pixel electrodes PE1 and PE3 show black. On the other hand, the electric charge of the pixel electrodes PE2 and PE4 is less than the electric charge of the common electrode CE, generating a potential difference of −15 V upward. Therefore, both the electrophoretic elements P2 and P4 arranged to face the pixel electrodes PE2 and PE4 show white. In this manner, if the TFTs of the pixel electrodes PE can withstand a voltage of 30 V, even though the electric charge of the common electrode CE is fixed to 15 V, which is the intermediate value between 0 V and 30 V, the pixel electrodes can be switched to and from 0 V and 30 V, thus making it possible to simultaneously rewrite one pixel from white to black and rewrite another pixel from black to white. Therefore, it is possible to rewrite a pixel to an arbitrary pixel state irrespective of the state of the EPD immediately before. Practically, however, a typical TFT cannot withstand a voltage of 30 V and a potential difference of approximately 15 V is needed between the common electrode and the pixel electrodes in order to rewrite electrophoretic elements of a typical size. Therefore, the above configuration cannot be employed.

Because of such a restriction, the display body 152 of the display terminal 1 employs the following configuration. That is, the display terminal 1 controls the voltage to be applied to each electrode as in CASE III to overwrite the display body 152 with black, and as in CASE IV in order to overwrite the display body 152 with white. Hereinafter, this configuration will be described in detail.

In CASE III, 0 V is applied to the common electrode CE and the pixel electrodes PE2 and PE4. A voltage of 15 is applied to the pixel electrodes PE1 and PE3 (see FIG. 5B). Thus, there is no upward or downward potential direction in the electrophoretic elements P2 and P4 and no electric field is generated. Therefore, the electrophoretic elements P2 and P4 maintain the state immediately before (i.e., CASE I). That is, the electrophoretic element P2 keeps showing black and the electrophoretic element P4 keeps showing white. Meanwhile, since an upward electric field is generated in the electrophoretic elements P1 and P3 (see FIG. 5C), black is displayed. That is, the electrophoretic element P1 keeps showing black as in the state immediately before, and the display state of the electrophoretic element P3 changes from white to black (see FIG. 5D).

In CASE IV, the voltage applied the pixel electrodes PE1 to PE4 is the same as described above, and 15 V is applied to the common electrode CE. In this case, the electrophoretic elements P1 and P3 maintain the state immediately before (i.e., CASE I), whereas a downward electric field is generated in the electrophoretic elements P2 and P4 (see FIG. 5C) and white is displayed. That is, the electrophoretic element P4 keeps showing white as in the state immediately before, and the display state of the electrophoretic element P2 changes from black to white (see FIG. 5D).

As described above, in CASE III, only rewriting from white to black is carried out and rewriting from black to white is not carried out. On the other hand, in CASE IV, only rewriting from black to white is carried out and rewriting from white to black is not carried out. The electric charge of the common electrode CE is different between CASE III and CASE IV. Therefore, the display body 152 of the display terminal 1 cannot simultaneously rewrite one pixel from white to black and rewrite another pixel from black to white.

### B. Operation

Next, the operation of the display terminal 1 will be described.

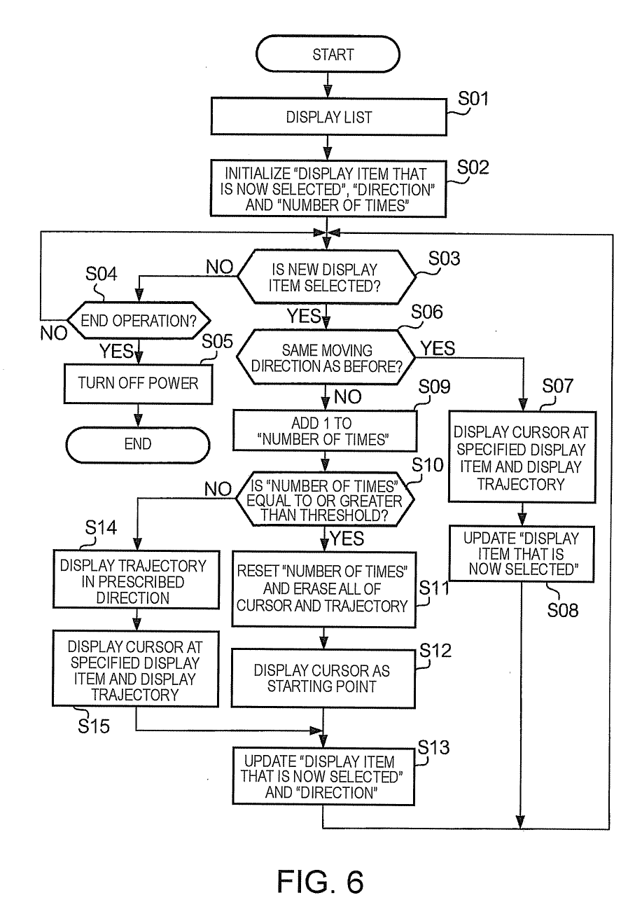

FIG. 6 is a flowchart for explaining a flow of operation in which the display terminal 1 displays transition of a display item selected by a user, in the display area of the display body 152.

In FIG. 6, first, as the user presses the switch of the operation unit 16, the CPU 11 of the display terminal 1 reads out display data from the display data storage area 142 of the storage unit 14 and drives the driving unit 151 of the display unit 15, thereby displaying a list corresponding to this display data on the display body 152 (step S01). At this time, the CPU 11 functions as an item display control unit which displays plural display items in the display area of the display body 152.

The plural display items constituting the list are laterally written character strings including serial numbers starting with “1” at the left end. These display items are arrayed from the top in ascending order of the serial number, in the vertical direction on the rectangular plane of the display body 152. Next, the CPU 11 of the display terminal 1 initializes each of the parameters “display item that is now selected”, “direction” and “number of times” (step S02). The parameter “display item that is now selected” is a parameter indicating the display item that is currently selected by the user. “Select” in this case means so-called focusing, that is, to focus on one display item of plural display items. Giving an instruction corresponding to this display item on which focus is given is referred to as “selection confirmation”, which is distinguished from “select”. When “selection confirmation” is given on one of the display item by the user, the CPU 11 carries out various processing corresponding to the display item in accordance with a program that is read in advance.

The parameter “direction” indicates the direction toward the newly selected display item from the display item that is selected immediately before, in accordance with the arraying order of the display items in the display area of the display body 152. The direction is either “up”, which is a value indicating an upward direction, or “down”, which is a value indicating a downward direction. The “number of times” represents the number of times the “direction” is changed.

By initialization, “1”, which is a value indicating the top of the list, is stored as the “display item that is now selected” in the item storage area 131. Similarly, by initialization, “down” is stored as the “direction” in the direction storage area 132, and “0” indicating 0 times is stored as the “number of times” in the number of times storage area 133.

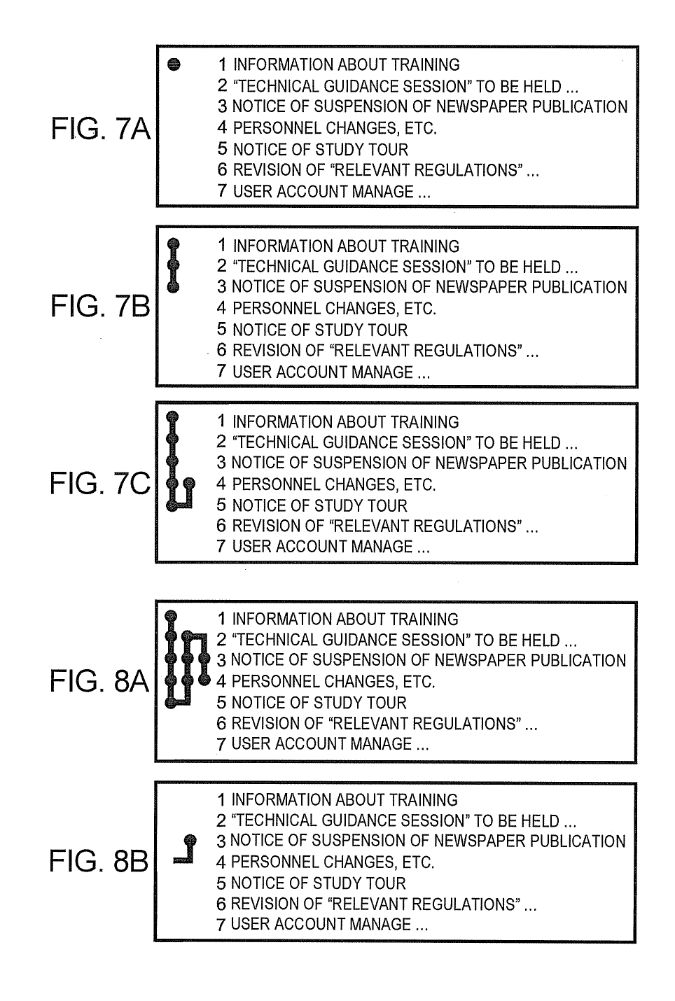

FIG. 7A to FIG. 7C illustrate how the display terminal 1 displays state transition of display item selection. FIG. 7A shows an exemplary display in the above initial state. As described above, in the initial state, the parameter value “1” is stored as the “display item that is now selected” in the item storage area 131. Although the display item that is actually selected by the user is not necessarily a display item corresponding to the parameter value “1”, here, it is assumed that the display item corresponding to the parameter value “1” is selected. Therefore, by referring to “1”, which is the value of this “display item that is now selected”, the CPU 11 specifies the display item that is regarded as being selected by the user, from plural display items. In this case, the CPU 11 rewrites the color of the pixels located at the position corresponding to the specified “display item that is now selected”, from white (first color) to black (second color), and displays an image showing that the display item is selected (hereinafter referred to as a specifying image), in the display area of the display body 152. That is, the CPU 11 functions as a specifying unit which specifies a display item selected by a user from displayed plural display items, and also functions as a specifying image display control unit which, when a first display item is specified from the plural display items by the specifying unit, rewrites the color of a pixel located at the position corresponding to the first display item from a first color to a second color and displays in the display area a first specifying image showing that the first display item is specified.

Thus, as shown in FIG. 7A, a black circle as a first specifying image is drawn to the left side of “1 Information about training” on the display body 152. This black circle is referred to as a cursor. Next, as the user operates a cross button on the operation unit 16, the operation unit 16 accepts this user's operation and supplies its operation signal to the CPU 11. Specifically, when the downward direction of the cross button is pressed, the operation unit 16 supplies the value obtained by adding 1 to the value of the current “display item that is now selected”, as the designated display item, and “down” as the designated moving direction, as operation signals to the CPU 11. Similarly, when the upward direction of the cross button is pressed, the operation unit 16 supplies the value obtained by subtracting 1 from the current “display item that is now selected”, as the designated display item, and “up” as the designated moving direction, as operation signals to the CPU 11. The CPU 11 of the display terminal 1 receives the operation signals from the operation unit 16 and determines whether a new display item is selected by the user or not (step S03). If a new display item is not selected (NO in step S03), the CPU 11 of the display terminal 1 determines whether the end of the operation is designated or not (step S04). If the end of the operation is designated (YES in step S04), the CPU 11 turns off the power of the display terminal 1 and ends control of the display terminal 1 (step S05). On the other hand, if the end of the operation is not designated (NO in step S04), the CPU 11 returns the processing to step S03. Thus, the CPU 11 continues to wait for operation signals from the operation unit 16.

Meanwhile, if a new display item is selected (YES in step S03), the CPU 11 of the display terminal 1 specifies the display item selected by the user. Then, the CPU 11 compares the direction toward the newly specified display item from the current “display item that is now selected” (that is, the designated moving direction) with the “direction” stored in the direction storage area 132 of the RAM 13 in accordance with the arraying order of the display items in the display area of the display body 152, and determines whether this “direction” and the designated moving direction are the same or not (step S06). If the “direction” and the designated moving direction are the same (YES in step S06), the CPU 11 displays a new cursor (second specifying image) to the left side of the newly specified display item while keeping the already displayed cursor (first specifying image) displayed, and then displays a trajectory connecting the cursor that is immediately before and the newly displayed cursor (step S07). The CPU 11 updates the “display item that is now selected” with the newly specified display item (step S08). The CPU 11 then returns the processing to step S03. The trajectory in this case is a straight line having a smaller width than the diameter of the cursor (black circle), as shown in the drawings.

In this way, the CPU 11 functions as the specifying image display control unit which, when a second display item is specified by the specifying unit after a first display item is specified, rewrites the color of a pixel located at the position corresponding to the second display item from the first color to the second color and displays in the display area a second specifying image showing that the second display item is specified, while keeping the first specifying image displayed.

Meanwhile, if the “direction” and the designated moving direction are different from each other (NO in step S06), the CPU 11 adds 1 to the “number of times” (step S09). Then, the CPU 11 reads out a threshold value stored in the threshold storage area 141 of the storage unit 14, compares the threshold value with this “number of times”, and determines whether the “number of times” is equal to or greater than the threshold value or not (step S10). The threshold value in this case is “3”. If the “number of times” is equal to or greater than the threshold value (YES in step S10), the CPU 11 resets the “number of times”, rewrites the color of the pixels representing the cursor and trajectory from black (second color) to white (first color), and erases all of them (step S11). The CPU 11 then draws a cursor as a starting point to the left side of the newly specified display item (step S12). Resetting the “number of times” refers to storing “0” indicating 0 times as the “number of times” in the number of times storage area 133. Then, the CPU 11 updates the “display item that is now selected” with the newly specified display item and updates the “direction” with the designated moving direction (step S13). The CPU 11 then returns the processing to step S03. If the “number of times” is smaller than the threshold value (NO in step S10), the CPU 11 displays a trajectory with a predetermined length in a predetermined direction from the current cursor (step S14) The CPU 11 displays a trajectory in the moving direction from the distal end of the previous trajectory, and displays a cursor at a position that is different from the position of the already displayed cursor and corresponds to the newly specified display item (in this case, to the left side) (step S15). The predetermined direction (hereinafter referred to as a prescribed direction) is the rightward direction. Therefore, in step S15, the cursor that is displayed here is displayed at a position that is different from the already displayed trajectory and a position on an extended line of the trajectory. After that, the CPU 11 updates the “display item that is now selected” with the newly specified display item, and updates the “direction” with the designated moving direction (step S13) The CPU 11 then returns the processing to step S03.

Next, change in selection state displayed by the display terminal 1 in accordance with an operation selected by the user will be described with reference to FIG. 7A to FIG. 7C, FIG. 8A and FIG. 8B. As described above, in the initial state, the display terminal 1 displays the selection state as shown in FIG. 7A. Here, if the user operates the cross button on the operation unit 16 and presses the downward direction twice, the display item shifts in order of “1”, “2” and “3”. The cursor and trajectory as shown in FIG. 7B are drawn on the display body 152 of the display terminal 1. The display item selected at this time is “3 Notice of suspension of newspaper publication”. If the user further operates the cross button to press the downward direction twice and then press the upward direction once, the display item shifts in order “1”, “2”, “3”, “4”, “5”and “4”. The cursor and trajectory as shown in FIG. 7C are drawn on the display body 152 of the display terminal 1. In this state, “up” is stored as the “direction” in the direction storage area 132 and “1” is stored as the “number of times” in the number of times storage area 133. The display item selected at this time is “4 Personnel changes, etc.”

Moreover, if the user then operates the cross button to press the upward direction twice and then press the downward direction twice, the display item shifts in order “1”, “2”, “3”, “4”, “5”, “4”, “3”, “2”, “3” and “4”. The cursor and trajectory as shown in FIG. 8A are drawn on the display body 152 of the display terminal 1. In this state, “down” is stored as the “direction” in the direction storage area 132 and “2” is stored as the “number of times” in the number of times storage area 133. Now, if the user operates the cross button and presses the upward direction, the designated moving direction is different from the “direction” stored in the direction storage area 132 of the RAM 13 and therefore 1 is added to the “number of times”, which becomes “3”. Moreover, this “number of times” is compared with the threshold value “3” stored in the threshold storage area 141. Therefore, the CPU 11 determines that the “number of times” is equal to or greater than the threshold value, and erases all of the cursor and trajectory (step S11). The CPU 11 then draws a cursor as a starting point to the left side of the newly specified display item (step S12). That is, a cursor is displayed to the left side of “3 Notice of suspension of newspaper publication” on the display body 152 of the display terminal 1. In addition to the display of the cursor, a trajectory to this cursor from the position where a cursor is located immediately before may also be displayed. In this case, for example, the cursor and trajectory as shown in FIG. 8B are drawn. By drawing the cursor and trajectory in this manner, the display terminal 1 can let the user to recognize the transition of the selection state of the display item while maintaining the state where only rewriting from white (first color) to black (second color) is possible.

According to the above embodiment, even if there is a restriction that the color of each pixel is rewritten only from one color to another color in one image writing process in the display area, the display terminal 1 can display which display item is selected, in a short time.

In the embodiment, since it is assumed that the processing starts with the display item that is now selected “1”, the specifying order can be identified by tracing the trajectory starting at “1”. Even if there is no such assumption, it is possible to learn the order in which display items are selected, by viewing the display of cursor and trajectory, because the user selects display items while actually watching the list screen.

### C. Modifications

The above embodiment may be modified as follows.

### Modification 1

In the above embodiment, the “number of times” indicating the number of times the “direction” is changed is used as a parameter for displaying the transition state of the selected display item. However, it is possible not to use the “number of times” as a parameter. In this case, if the CPU 11 determines in step S06 that the “direction” and the designated moving direction are different from each other (NO in step S06), the CPU 11 can carry out steps S11, S12 and S13 without carrying out steps S09 and S10 (that is, without carrying out steps S14 and S15, either). In this case, the prescribed direction need not be defined. This is because the displayed cursor and trajectory are erased when the direction is changed.

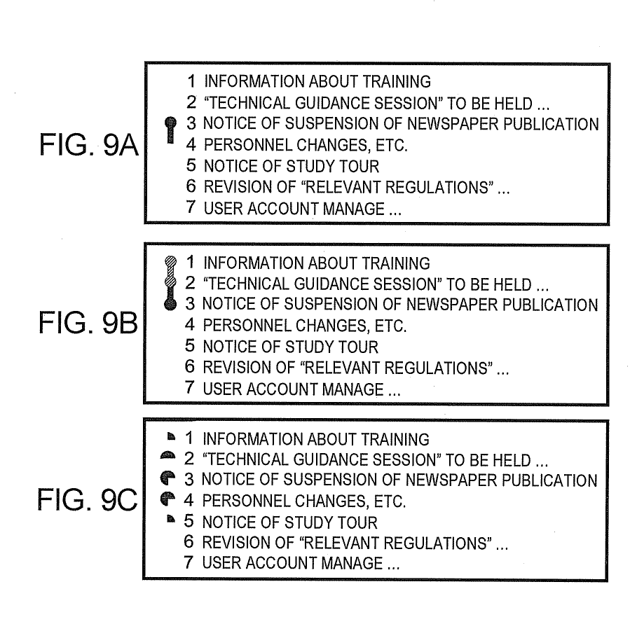

Moreover, in step S12, a cursor as a starting point may be drawn to the left side of the designated display item, and a trajectory may be drawn toward the newly drawn cursor from the position where a cursor is located immediately before. FIG. 9A shows the display state immediately after the selected display item shifts in order of “1”, “2”, “3”, “4”and “3” in this example. In FIG. 9A, a trajectory is drawn toward the position “3” where a cursor is currently located, from the position “4” where a cursor is located immediately before. In this manner, when the direction selected by the user is changed, it is possible to clarify the direction from which the movement is made to select the currently selected display item.

### Modification 2

In the above embodiment, the display content of the display terminal 1 does not change in accordance with elapsed time from the time when the user carries out an operation via the operation unit 16. However, the display content of the display terminal 1 may be changed in accordance with the elapsed time. For example, of the cursor and trajectory selected and drawn in the past, some pixels may be rewritten from black to white, thus making these cursor and trajectory look lighter, as shown in FIG. 9B. Specifically, the CPU 11 includes a timer with an oscillating circuit having a crystal oscillator. Every time an operation signal is supplied from the operation unit 16 and a cursor is displayed, the CPU 11 stores the time indicated by the timer to the RAM 13 as a cursor display time. Then, the CPU 11 measures the difference between the current time indicated by the timer and the cursor display time immediately before which is stored in the RAM 13, as the elapsed time after the cursor is displayed. The CPU 11 then determines whether the elapsed time exceeds a threshold value stored in advance in the storage unit 14. If it is determined that the elapsed time exceeds the threshold value, the CPU 11 rewrites some pixels from black to white in accordance with a predetermined pattern, with respect to the cursor and trajectory drawn before the cursor display time. The predetermined pattern is a pattern to express halftone, for example, a checkered pattern or a group of slant lines. As described above, the active matrix EPD is restrained in that it is not possible to simultaneously rewrite one pixel from white to black and another pixel from black to white in one image writing process. However, if there is no operation for a while after one pixel is rewritten from white to black, it is often the case that the user does not request drawing directly corresponding to the user's operation and doesn't even watch the screen. That is, in such cases, there is an enough time to switch the drawing mode. Therefore, even if the display terminal 1 carries out the above drawing by switching a drawing mode of rewriting a pixel from white to black to a drawing mode of rewriting a pixel from black to white, the operability for the user is not undermined. By doing so, the user can more clearly identify the specifying order of the display item that is specified immediately before and the currently specified display item. It is also possible to rewrite all the pixels of the cursor and trajectory drawn before the cursor display time, from black to white. In this case, these cursor and trajectory are erased.

### Modification 3

In the above embodiment, the display terminal 1 draws a trajectory together with a cursor. However, the trajectory need not be drawn. For example, it is possible to draw a black circle alone, as a cursor. Also, figures of various other shapes than black circle can be used as cursors. For example, figures obtained by quadrisecting the above black circle with vertical and horizontal lines passing through its center, that is, sectors with a central angle of 90 degrees, may be used as cursors. FIG. 9C shows how the display terminal 1 displays the state transition of display item selection in this modification. As shown in FIG. 9C, for the first selected display item, the top right sector of these cursors may be displayed. For the second selected display item, the top left sector may be displayed in addition to the top right sector. For the third selected display item, the bottom left sector may be added to the display. In this way, the user can infer the selection order of the display items by comparing each display item with the display items above and below. Therefore, the specifying order of the display item that is specified immediately before and the display item that is currently specified and selected can be identified.

### Modification 4

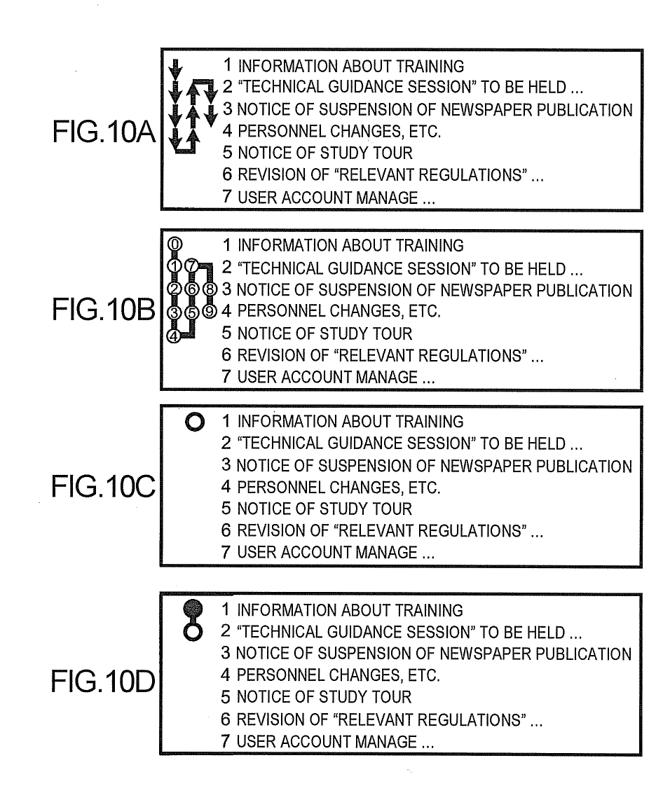

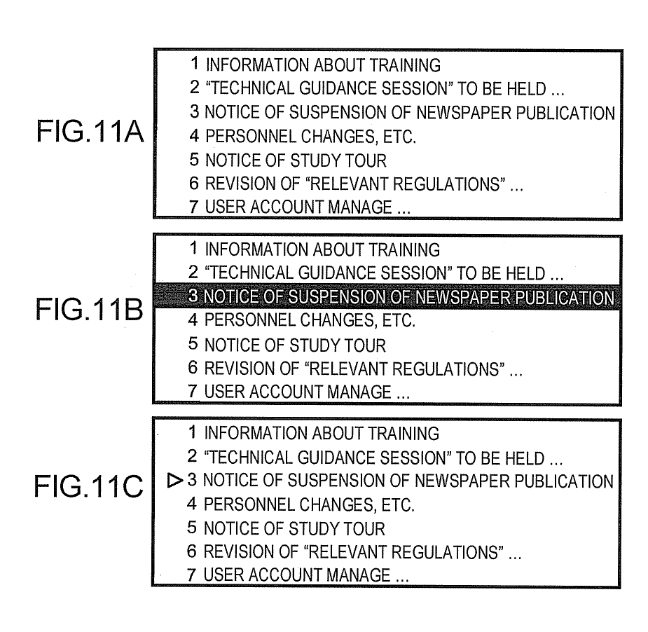

In the above embodiment, a cursor is a black circle and a trajectory is a straight line having a smaller width than the diameter of the black circle. However, the cursor and trajectory may be combined and expressed as an arrow. FIG. 10A shows how the display terminal 1 displays the state transition of display item selection in this modification. In the above embodiment, a cursor is a vertically symmetrical black circle. Therefore, it is possible to interpret, for example, the display as shown in FIG. 7B, both as transition of the selected display item in order of “1”, “2” and “3”, and as transition of the selected display item in order of “3”, “2” and “1”. Particularly, if the user is not aware of the assumption that the processing starts with the display item that is now selected “1”, or if the user sees the list screen for the first time after plural operations were carried out, it may not be clear which order is employed to select display items. However, as the display terminal 1 expresses the movement between display items by an arrow as shown in FIG. 10A, the user can clearly identify the specifying order of the display item that is specified immediately before and the currently specified display item simply by viewing the displayed image.

### Modification 5

For cursors, characters may be added instead of uniformly using the same black circle. For example, numbers may be described in cursors such as “0”, “1”, “2”, . . . and “9” according to the selecting order, as shown in FIG. 10B. Again, by doing so, the user can more clearly identify the specifying order of the display item that is specified immediately before and the currently specified display item.

### Modification 6

Alternatively, a white circle with a black outline may be used as a cursor indicating the currently selected display item, and a black circle may be used as a cursor indicating a display item that is selected in the past. In the initial state, the display terminal 1 draws a white circle with a black outline as a cursor indicating the currently selected display item, to the left of “1 Information about training”, as shown in FIG. 10C. Now, if the user presses the downward direction of the cross button once, the display terminal 1 draws a white circle with a black outline as a cursor indicating the currently selected display item, to the left of “2“Technical guidance session” to be held . . . ”, and repaints in black the inside of the white circle with a black outline which is drawn immediately before and thus changes the white circle into a black circle. Then, the display terminal 1 draws a trajectory, which is a line having a smaller with than the diameter of the black circle, between the black circle and the white circle with a black outline. As a result, the display terminal 1 displays the transition state of the selected display item, as shown in FIG. 10D. Again, by doing so, the user can more clearly identify the specifying order of the display item that is specified immediately before and the currently specified display item.

### Modification 7

In the above embodiment, plural display items constituting a list are arrayed from the top in ascending order of their serial number, in the longitudinal direction of the rectangular plane of the display body 152. However, the specific arraying method to be employed is not limited to this. For example, the display items may be arrayed from right in the lateral direction of the rectangular plane of the display body 152. In this case, the “direction” is either “left” indicating left or “right” indicating right. The “prescribed direction” may be up or down.

### Modification 8

The invention may also be realized as a program executed by the CPU 11. The program can be provided as recorded on recording media such as a magnetic tape, magnetic disk, optical recording medium, magneto-optical recording medium, CD (compact disk), DVD (digital versatile disk), and flash memory.

Japanese Patent Application No. 2008-072103 filed on Mar. 19, 2008, is hereby incorporated by reference in its entirety.

What is claimed is:

1. A display method in a display device having a display area including plural pixels and in which color of each pixel is rewritten from one color to another color in one image writing process, the method comprising:
displaying plural display items in the display area;
specifying a display item selected from the displayed plural display items;
rewriting the color of the pixel located at a position corresponding to a first display item specified by the specifying, from a first color to a second color; and
displaying in the display area a first specifying image showing that the first display item is specified, and when a second display item is specified after the first display item is specified, rewriting the color of the pixel located at a position corresponding to the second display item from the first color to the second color while keeping the first specifying image displayed, and displaying in the display area a second specifying image showing that the second display item is specified.

2. A display device comprising:
a display unit which has a display area including plural pixels and in which color of each pixel is rewritten from one color to another color in one image writing process in the display area;
an item display control unit which displays plural display items in the display area;
a specifying unit which specifies a selected display item, from the displayed plural display items; and
a specifying image display control unit which, when a first display item is specified by the specifying unit from the plural display items, rewrites the color of the pixel located at a position corresponding to the first display item from a first color to a second color and displays in the display area a first specifying image showing that the first display item is specified, and when a second display item is specified by the specifying unit after the first display item is specified, rewrites the color of the pixel located at a position corresponding to the second display item from the first color to the second color while keeping the first specifying image displayed, and displays in the display area a second specifying image showing that the second display item is specified.

3. The display device according to claim 2, wherein the specifying image display control unit rewrites the color of the pixel located at the position corresponding to the second display item from the first color to the second color, and displays in the display area the second specifying image which shows that the second display item is specified and which enables identification of a specifying order of the first display item and the second display item.

4. The display device according to claim 2, wherein when a display item specified by the specifying unit in the past is selected and specified again by the specifying unit,
the specifying image display control unit displays the second specifying image at a position which is different from the position of the specifying image displayed when the display item is specified by the specifying unit in the past and which corresponds to the display item specified again by the specifying unit.

5. The display device according to claim 2, wherein the specifying image display control unit
displays an image in a predetermined shape as the first specifying image at a position corresponding to the first display item,
displays an image in a predetermined shape as the second specifying image at a position which corresponds to the second display item and is in an arraying direction of the display item as viewed from the image in the predetermined shape displayed corresponding to the first display item, and displays a trajectory image connecting the image in the predetermined shape displayed at the position corresponding to the first display item and the image in the predetermined shape displayed at the position corresponding to the second display item, as the second specifying image,
stores a direction from the first display item toward the second display item in accordance with an arraying order of the display items in the display area, and
displays the second specifying image at a position which is different from the already displayed trajectory image and from a position on an extended line of the trajectory image, in displaying the second specifying image when the stored direction is changed.

6. The display device according to claim 5, wherein if the number of times the direction is changed exceeds a threshold value, the specifying image display control unit rewrites the color of a pixel representing the displayed specifying image from the second color to the first color and erases the specifying image.

7. The display device according to claim 2, wherein the specifying image display control unit measures an elapsed time after the second specifying image is displayed, and if the elapsed time exceeds a threshold value, the specifying image display control unit rewrites the color of at least a part of plural pixels representing the specifying image displayed before the second specifying image, from the second color to the first color.
